(19) United States
(12) Patent Application Publication
(10) Pub. No.: US 2003/0206192 A1
(43) Pub. Date: Nov. 6, 2003

(54) Asynchronous message push to web browser

(76) Inventors: Mingte Chen, Fremont, CA (US); Sing Yip, Castro Valley, CA (US); Yan Ma, Castro Valley, CA (US); Gilberto Arnaiz, Redwood City, CA (US); Srikant Krishnapuram Tirumalai, Mountain View, CA (US); David Tchankotadze, Sunnyvale, CA (US); Kuang Huang, Fremont, CA (US); Anil Kumar Annadata, Milpitas, CA (US)

Correspondence Address: SKJERVEN MORRILL LLP, 25 METRO DRIVE, SUITE 700, SAN JOSE, CA, 95110, US

(21) Appl. No.: 10/033,146

(22) Filed: Oct. 27, 2001

Related U.S. Application Data
(63) Continuation-in-part of application No. 09/823,531, filed on Mar. 31, 2001.
(60) Provisional application No. 60/326,345, filed on Sep. 29, 2001.

(51) Int. Cl. G09G 5/00

(52) U.S. Cl. 345/733

(57) ABSTRACT

A method and system for controlling a user interface presented by a web browser. A web server pushes an asynchronous message to the web browser. The web browser is not blocked waiting for the asynchronous message. The web browser presents a user interface and presents a user interface change in response to receiving the asynchronous message.

### CROSS-REFERENCE TO RELATED APPLICATIONS

This application is a continuation in part of parent application Ser. No. 09/823,531 (attorney docket M-1 1528 US, client reference SIEB062/US), filed on Mar. 31, 2001, entitled “User Interface for Multi-Channel Communication” and naming Mingte Chen, Anil K. Annadata, and Kuang Huang as inventors, the application being incorporated herein by reference in its entirety.

This application also claims priority to provisional application serial No. 60/326,345 (attorney docket M-11528 V1 US, client reference SIEB111/00USP), filed on Sep. 29, 2001, entitled “Asynchronous Message Push to Web Browser” and naming Mingte Chen, Sing Yip, Yan Ma, Gilberto Arnaiz, Srikant Tirumalai, David Tchankotadze, Kuang Huang, and Anil K. Annadata as inventors, the application being incorporated herein by reference in its entirety.

### BACKGROUND OF THE INVENTION

1. Field of the Invention

The present invention relates to communication via the Internet, and more particularly, to a user interface controlled by asynchronously pushing messages to a web browser.

2. Description of the Related Art

The Internet operates under a client/server model of information delivery. In this model, a client computer connects to a server computer on which information resides. The client depends upon the server to deliver information. In effect, the client requests the services of the server. These services may involve searching for information and sending it back to the client, such as when a database accessible by the server is queried. Other examples of these services are delivering web pages from a server on the World Wide Web, hereinafter referred to as a “web server,” and handling incoming and outgoing mail. A user of the Internet connects to a server computer and requests the use of the server's resources.

Typically, the client computer is a local personal computer and the server computer (also known as the host) is a more powerful computer that houses the data or that has access to another computer system that houses the data. The connection to the server is made via a telephone line, a local area network (LAN), or a TCP/IP-based wide area network (WAN) on the Internet. For the web, web browser software such as Microsoft Internet Explorer running on the client computer is the client of the client/server relationship. The server of the client/server relationship is typically web server software such as Microsoft Internet Information Server (IIS) running on the server computer. The client/server relationship allows many clients to access the same applications and files that are stored on a server.

A typical communication on the web involves the web browser sending the web server a request for a specific web page, and the web server processing the request and sending a response in the form of a web page back to the web browser. The request and response are communicated using Hypertext Transfer Protocol (HTTP), the protocol of the web, with an underlying Transport Control Protocol/Internet Protocol (TCP/IP) to transfer the request and response.

Generally, communication over a network can be performed either synchronously, where the requester sends a message and is blocked waiting for a response to come back, or asynchronously, where the requester sends a message and does not wait for a response to come back. The term synchronous is used herein to describe a situation where the requester, a web browser, is blocked waiting for a response to an HTTP request, and the term asynchronous is used to describe a situation where the web browser is not blocked even though no response to the HTTP request has been received. When a response does arrive for an asynchronous request, the requester is notified by the sender that the response is ready and can choose to accept the response.

Web browsers are designed to be very secure and thus receive information from a web server in a strictly synchronous manner. In a web connection, a TCP/IP connection to the Internet is established when the user starts the web browser. An HTTP connection is established when the web browser requests a web page from the web server. The HTTP connection between the client and server is maintained only during the actual exchange of information. Thus, after a web page is transferred from the web server, the HTTP connection between the server computer and the client computer is closed. Even though the HTTP connection is closed, the user of the web browser remains connected to the Internet via the TCP/IP connection.

The client/server model enables the client computer to run the web browser software to search the web and to access host servers around the Internet to execute search and retrieval functions. In essence, the client/server model enables the web to operate as a limitless file storage medium and database, distributed among thousands of host computers, all accessible by any individual personal computer running a web browser.

Because the Internet operates under a client/server model, the client web browser is designed so that the web browser must request information from the web server in order to receive information. If the client web browser does not receive a response from the web server in a relatively short time period, usually no more than a few minutes, the attempt to establish an HTTP connection will be aborted. The web browser is blocked so that it cannot do other things while it is waiting for a response from the web server.

Similarly, if a web server is trying to send a response to a web browser and the HTTP connection has been lost, the attempt to send will abort after a relatively short time period. Consequently, a web browser is not designed to wait indefinitely for a response, but rather to receive web pages almost instantaneously from the web server.

However, it is sometimes desirable for a server to be able to “push” information to a client. For example, the Internet sometimes is used to broadcast information to individuals using a technology known as push technology. Using push technology, data are automatically delivered into client computer systems at prescribed intervals or based upon the occurrence of particular events. These particular events may include automatically generated requests, or automated pulls, of information, so that Internet users automatically receive certain information without each user requesting the information each time.

Typically, an Internet user subscribes to a service that provides push technology in order to receive specific types of information. Web sites providing push technology are often referred to as “channels,” and typically channels provide information in a particular area of interest. The publisher of the channel builds the information and sends the information to subscribers automatically at intervals specified by the subscriber.

These subscription channels typically are implemented to include a subscription software program that is downloaded to the subscriber's computer. The subscription software program regularly runs at the specified intervals, requests the web pages of interest, and checks for updates in the channel. Updates may be stored on the requesting client computer's hard drive so that the user can view the information later and without being logged onto the Internet.

Web browsers are designed so that the web browser will not accept data or web pages unless those web pages are first requested by the web browser. Operating under the client/server synchronous request/response model ensures that users do not receive unsolicited web pages or data files, as such “spamming” would be very disruptive to the user's session on the client computer or to the machine itself. Subscription channels overcome this limitation by obtaining prior approval from the user to perform the request on behalf of the subscribing user at specified intervals. However, subscription channels may require additional software to be installed on the client computer system.

Because of the ubiquity of the Internet, many enterprises are striving to develop software that can be used with only a standard web browser so that additional software is not needed to be installed on the client computer system. For example, in a large customer support organization, it may be desirable for customer support agents to be able to access applications from their home computers, while traveling, and in other locations where specialized application software may be unavailable. However, web browsers are designed primarily to request and display web pages and not to perform sophisticated interactions with servers. Therefore, providing a complex user interface has heretofore been limited to providing more sophisticated client software.

In some situations, it may be desirable for the web server to be able to push information asynchronously to the web browser supporting an application such as the customer support application, without the user of the web browser first requesting a web page. The term “asynchronous message” is used herein to refer to a message sent by the web server, where the message is not a synchronous response to the web browser's request for a web page and the web browser is not blocked waiting for the message. An example of a situation in which such an asynchronous message push would be desirable would be when an event occurs about which the user should be immediately notified. The web server could immediately notify an agent of an event when urgent help is needed, even when the agent is not currently accessing a particular web site.

Without requiring an application program to be installed on the client computer system, enabling the web server to asynchronously push a message is difficult. If a subscription channel were to implement a completely browser-based client, the subscription channel would provide updates to the user only when the user logged onto the subscriber's web site and would not provide updates at specified intervals. The user would have to log onto the web site in order to receive the updates. Only if the user could stay continuously connected to the subscription service's web site could the subscription service ensure that updates are received immediately. It is unlikely that a subscription service would be willing to provide enough continuous connections to service a large base of subscribers. This solution is not scalable.

Another solution is to have a program such as a Java applet spawn a listening thread on a port of the client computer system so that the web server can push information whenever appropriate. However, the port would be subject to receiving messages from any application aware of the port, not just from the web server. This solution poses a security risk. In addition, the web server must remember every client so that messages are pushed to the correct client. The web server must also to initiate a connection to the appropriate port to push the asynchronous message to the corresponding client.

Yet another solution is to cause the web browser to continuously poll the web server to ask whether the web server has a message to be delivered to the web browser. However, this solution is not scalable either. For example, a customer support application with thousands of customer support agents sending constant polling requests may overwhelm the web server. The web server may become a bottleneck unable to adequately service normal requests.

What is needed is a secure and scalable way to allow a web server to asynchronously push a message to a web browser. It is desirable that the web browser not be blocked in order to receive information from the web server so that the web browser can perform other tasks. It is also desirable that the web browser be protected from receiving unwanted messages.

### SUMMARY OF THE INVENTION

The present invention provides a method and system for controlling a user interface presented by a web browser.

In one aspect, the method includes controlling a user interface presented by a web browser. The method further includes causing a web server to push an asynchronous message to the web browser, wherein the web browser presents a user interface change in response to the asynchronous message.

In another aspect, the method includes controlling a user interface presented by a web browser by registering the web browser as available to receive an asynchronous message. The web browser is not blocked waiting for the asynchronous message. The method further includes causing a web server to push the asynchronous message to the web browser, wherein the web browser presents a user interface change in response to the asynchronous message.

In yet another aspect, the method includes controlling a user interface presented by a web browser by causing the web browser to provide a wait request to a web server, the wait request being associated with the web browser. The method further includes identifying a source of an asynchronous message and associating the wait request with the source, wherein the associating identifies the web browser as a recipient of the asynchronous message. The method further includes pushing the asynchronous message to the web browser, wherein the browser presents a user interface change in response to the asynchronous message.

A computer system, a computer program product and a system for implementing each of the above methods are also provided.

The foregoing is a summary and thus contains, by necessity, simplifications, generalizations and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features and advantages made apparent to those skilled in the art by referencing the accompanying drawings.

FIG. 1 is a diagram of one embodiment of a client/server system in which the asynchronous message push to browser is used.

FIG. 2 shows the core components involved in asynchronously pushing a message to a web browser client.

FIG. 3 is a flowchart for pushing an asynchronous message to the web browser client of FIG. 1.

FIG. 4 is a more detailed diagram showing the communication infrastructure of the embodiment of the client/server system of FIG. 1.

FIG. 5 shows the operation of the client/server system of FIG. 1 in performing the Prepare to Receive Asynchronous Message step of the flowchart of FIG. 3.

FIG. 6 shows the operation of the client/server system of FIG. 1 in performing the Push Asynchronous Message step of the flowchart of FIG. 3.

The use of the same reference symbols in different drawings indicates similar or identical items.

### DETAILED DESCRIPTION

The following is intended to provide a detailed description of an example of the invention and should not be taken to be limiting of the invention itself. Rather, any number of variations may fall within the scope of the invention which is defined in the claims following the description.

In the following description, for purposes of explanation, numerous specific details are set forth in order to provide a thorough understanding of the invention. It will be apparent, however, to one skilled in the art that the invention can be practiced without these specific details.

References in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

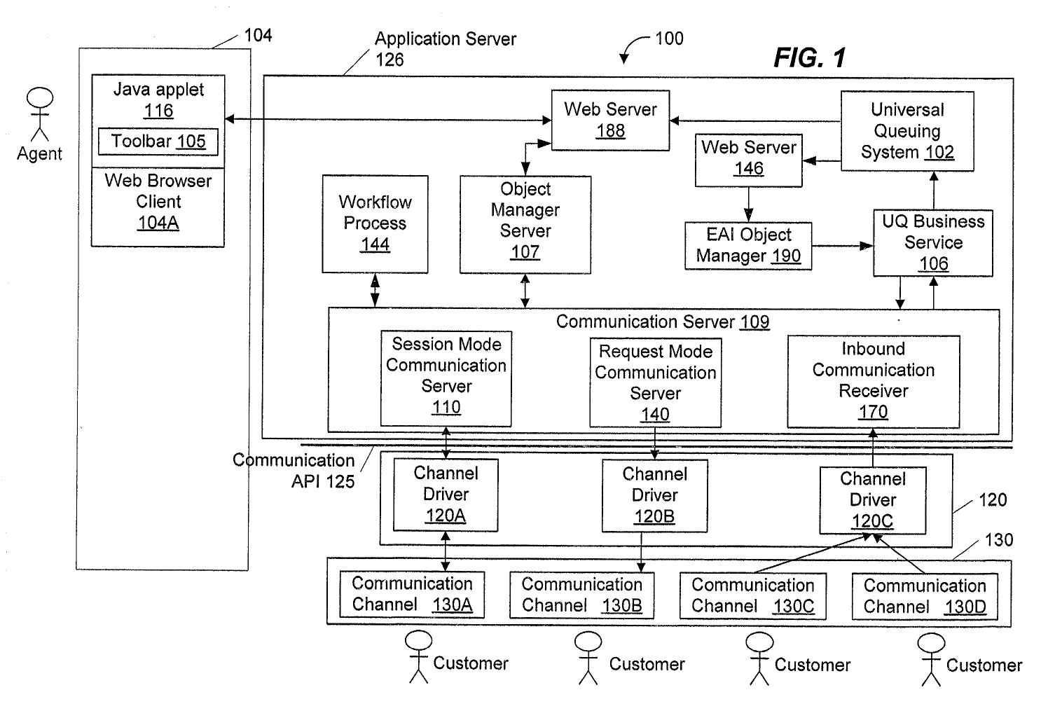

FIG. 1 is a diagram of one embodiment of a client/server system 100 for enabling a agents to respond to customer support requests and/or information requests via multiple communication channels of different media types. Client/server system 100 is described in more detail in parent application Ser. No. 09/823,531 (attorney docket M-11528 US, client reference SIEB062/US), filed on Mar. 31, 2001, entitled “User Interface for Multi-Channel Communication” and naming Mingte Chen, Anil K. Annadata, and Kuang Huang as inventors. Client/server system 100 is an example of a system which uses the asynchronous push of messages from web servers to web browsers, although the invention is not so limited. The ability to push messages asynchronously to web browsers is applicable to any software application that is accessible via the Internet.

Client/server system 100 enables asynchronous messages to be sent to web browser client 104A to control a toolbar 105 providing a user interface for a customer support agent. The asynchronous messages notify the client of incoming communication via one or more communication channels. Client/server system 100 supports communication channels of different media types. These media types include, but are not limited to, telephone, email, fax, web collaboration, Internet call me now and call me later, web chat, wireless access protocol, paging, and short messaging services.

Three types of client 104 are described in the parent application, web browser client 104A, thin client 104B, and dedicated client 104C. Because this invention enables the client/server system 100 to operate with only a web browser as a client, the discussion of this application is limited to web browser client 104A.

Web browser client 104A includes a web browser program such as Microsoft's Internet Explorer running on a client computer system (not shown). Web browser client 104A communicates with web server 188 and receives messages that are asynchronously pushed from web server 188 to web browser client 104A. Web browser client 104A includes the capability to download instructions, such as a Java applet, from a web server, such as web server 188, and to execute the instructions.

Application server 126 in client/server system 100 performs functions for and sends information to web browser client 104A via web server 188, which provides web pages and other user interface changes for web browser client 104A to display.

Web browser client 104A is shown including toolbar 105. One of skill in the art will recognize that other user interfaces providing the functionality of a toolbar are within the scope of the invention. Toolbar 105 is presented as part of a user interface via web browser client 104A.

Communication server 109 includes session mode communication server 110, request mode communication server 140, and inbound communication receiver 170. Each of these communication servers 110, 140, 170 may include the capability to asynchronously push messages. However, because session mode communication server 110 controls the user interface presented by web browser client 104A, the discussion of this application is limited to the functionality of session mode communication server 10.

Furthermore, several of the examples herein illustrate asynchronous messages related to communication via telephone, such as notifying the user of an incoming telephone call, although the invention supports asynchronous messages of any type, whether related to communication or not.

An agent, also referred to herein as a user, using web browser client 104A logs into client/server system 100 by accessing an enterprise web page via web server 188. A session is established for the agent to receive communications from and send communications via at least one communication channel 130.

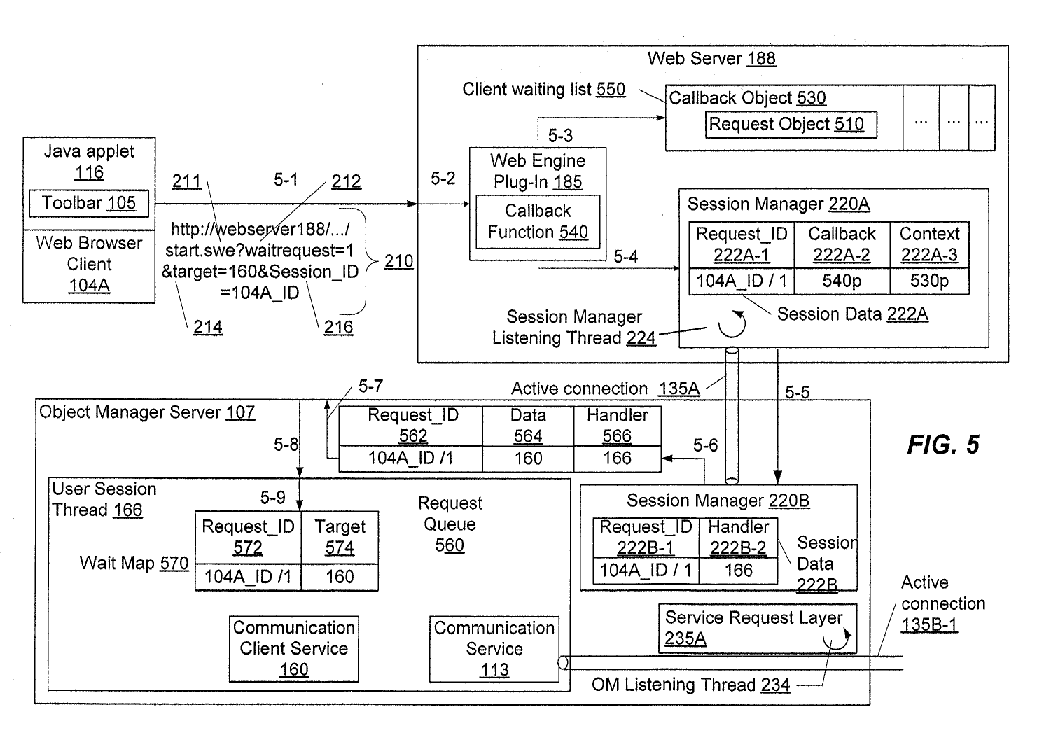

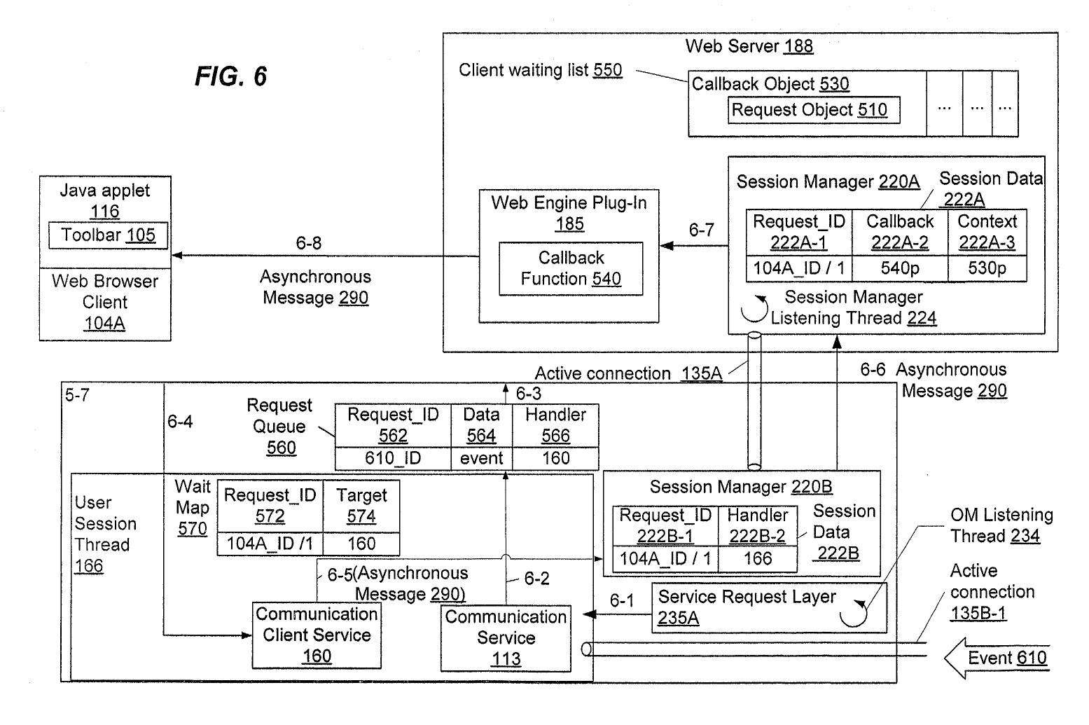

Sessions are logical connections from web server 188 to another business process server, here called object manager server 107, that provides access to business objects and business logic. The business process server determines when a message is to be pushed asynchronously to web browser client 104A. In client/server system 100 described herein, object manager server 107 may, in turn, extend this logical connection by connecting to one or more additional servers providing specific business functionality, such as session mode communication server 110. Sessions are discussed in further detail with reference to FIGS. 5 and 6.

In client/server system 100, session mode communication server 110 provides the ability for the agent to communicate via communication channels 130, such as communication channels 130A, 130B, 130C, and 130D, of different media types using a single user interface provided via web browser client 104A. To accomplish this communication, channel drivers 120, such as channel drivers 120A, 120B, and 120C, provide media-specific communication via communication API 125. Communication API 125 enables session mode communication server 110 to operate independently of the communication channel's media type and specific protocols.

This three-tier architecture of web browser client 1 04A, web server 188, and a business process server (object manager server 107) enables web server 188 to deal with serving web page requests and offloads business logic to other components of client/server system 100. It is important to note that the functionality provided by servers such object manager server 107, communication server 109 and session mode communication server 110 can be implemented on one server computer system or distributed across two or more server computer systems. Furthermore, these servers can reside on the same computer system as web server 188, although large enterprises typically dedicate a particular computer system entirely to performing the functions of web server 188 and have many web servers such as web server 188.

In one embodiment, application server 126 of client/server system 100 includes object manager server 107, session mode communication server 110, request mode communication server 140, inbound communication receiver 170, Universal Queuing (UQ) system 102, UQ business service 106, web server 188, web server 146, Enterprise Application Interface (EAI) object manager 190, and workflow process 144, as shown in FIG. 1. In one embodiment, communication between components in application server 126 is enabled using a suitable inter-process communication protocol in conjunction with a transfer protocol such as transfer control protocol/Internet protocol (TCP/IP), as known in the art. These components and interactions between them are described in further detail in the parent application and in the related patent applications cited in the Cross Reference to Related Applications section of this patent application.

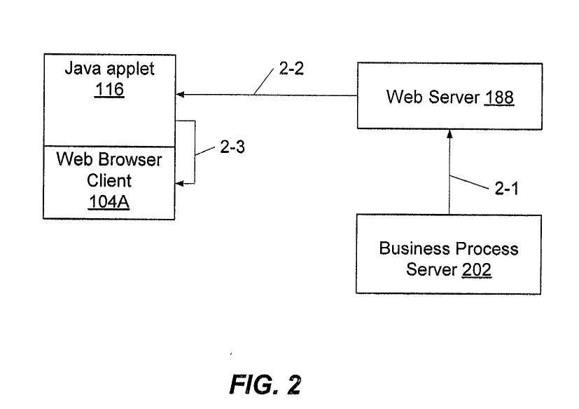

FIG. 2 shows the three-tier architecture for performing an asynchronous push to a web browser. Business process server 202 is the originator of an asynchronous message. In action 3-1, business process server 202 causes web server 188, which includes standard off-the-shelf web server software such as Microsoft Internet Information Server (IIS) or Apache, to push the asynchronous message in action 3-2 to Java applet 116. In action 3-3, Java applet 116 controls a user interface presented by web browser client 104A. In one embodiment, Java applet 116 controls a toolbar that agents use to communicate via multiple communication channels of different media types.

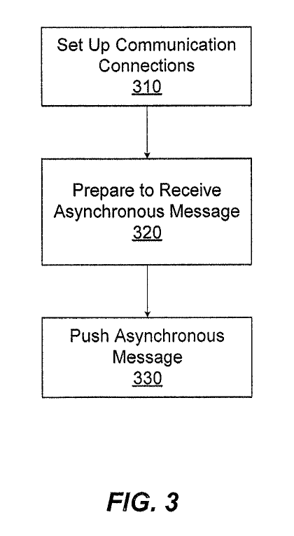

FIG. 3 is a flowchart of an embodiment of a method of pushing an asynchronous message to a web browser client. In Set Up Communication Connections step 310, communication connections are established between the web browser, web server and a business process server that is responsible for determining that an asynchronous message should be pushed to the web browser. These communication connections are established to enable the business process server(s) to communicate with the web server and the web browser client at any time to push an asynchronous message.

In Prepare to Receive Asynchronous Message step 320, the web browser client is registered with the business process server to indicate that the web browser client can receive an asynchronous message. In Push Asynchronous Message step 330, the asynchronous message is pushed to the web browser client. Prepare to Receive Asynchronous Message step 320 is described further with respect to FIG. 5, and Push Asynchronous Message step 330 is described further with respect to FIG. 6.

Communication Infrastructure

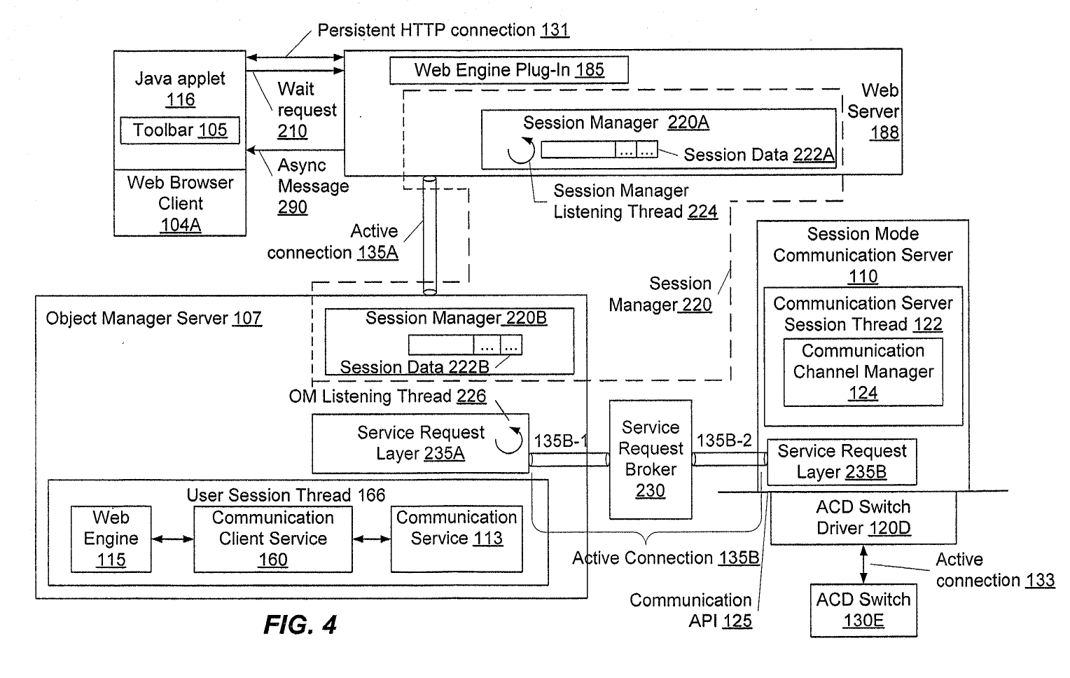

FIG. 4 shows the result of performing Set Up Communications Connections step 310 for the embodiment of the invention shown in FIG. 1. The components of FIG. 4 include web browser client 104A, web server 188, which communicates directly with web browser client 104A, and two business process servers, object manager server 107 and session mode communication server 110. The invention is operable with only one business process server, but two business process servers are used to illustrate the operation of the present invention with regard to client/server system 100 of FIG. 1.

Describing the communication connections in the context of the present invention, Java applet 116 causes web browser client 104A to send wait request 210 to web server 188 as part of a normal HTTP request. Ultimately, via the communication infrastructure shown in FIG. 4, asynchronous message 290 is sent asynchronously from web server 188 to web browser client 104A.

Referring to web server 188, web engine plug-in 185 provides the functionality to use an off-the-shelf web server, such as Microsoft Internet Information Server (IIS), to communicate with session manager 220, object manager server 107 and the rest of client/server system 100. Session mode communication server 110 originates the asynchronous message and uses object manager server 107 to process and push the asynchronous message to web server 188. Web engine plug-in 185 pushes the asynchronous message from web server 188 to web browser client 104A via persistent HTTP connection 131.

Session mode communication server 110 controls the user interface presented by web browser client 104A by causing web server 188 to push asynchronous messages. Session mode communication server 110 communicates with web browser client 104A via a series of connections between session mode communication server 110, object manager server 107, and web server 188. As described above, sessions are logical connections from web server 188 to object manager server 107. In this example, for web browser client 104A, the logical connection from web server 188 to the first business process server, object manager server 107, uses active connection 135A. This logical connection is further extended to a second business process server, session mode communication server 110, via a connection such as active connection 135B. Note that a second connection is not required for the operation of the present invention but is included for illustration purposes for the specific embodiment shown.

In the embodiment shown in FIG. 4, active connection 135B is comprised of sub-connection 135B-1 between Service Request Layer 235A and Service Request Broker 230 and sub-connection 135B-2 between Service Request Broker 230 and Service Request Layer 235B. Splitting a connection into sub-connections is related to the particular embodiment shown and is not a requirement of the present invention.

Processes corresponding to a particular web browser client 104A run on each of the business process servers related to a session. In the example shown, user session thread 166 runs on object manager server 107 and communication server session thread 122 runs on session mode communication server 110. User session thread 166 and communication server session thread 122 are described in more detail in the parent application cross-referenced above. In the embodiment shown, communication between user session thread 166 and communication server session thread 122 is accomplished using Service Request Broker 230 via active connection 135.

Session mode communication server 110 maintains knowledge of each client 104 to which it is connected, here web browser client 104A. Session mode communication server 110 receives incoming events such as customer support requests and communicates interactively with the agent by asynchronously pushing messages to a user interface presented to the agent. Preferably the incoming customer support request is communicated to the agent at substantially the same time the customer support request is received by the communication channel 130, with brief intermissions only to allow for processing and transport time in transporting the customer support request. This ensures that the customer's waiting time is minimized, particularly for requests for live interaction with an agent.

When an event such as arrival of an incoming telephone call occurs, the user interface notifies the agent using a notification function to change the user interface to capture the agent's attention. For example, a notification function of the user interface can receive an asynchronous message and provide an action instruction to cause a button to blink to notify the agent of the phone call. The notification function can also provide an action instruction to display other information, such as information about the caller (referred to herein as a “screen pop”) before the agent picks up the phone. When the agent uses toolbar 105 to accept a telephone call, put a call on hold, or release a call, the user interface sends a command to session mode communication server 110, which communicates with one of channel drivers 120 to issue the command to the communication channel controlling the telephone.

Having the capability to asynchronously push a message from a communication channel enables the agent to receive an incoming work item, such as an email, intended specifically for that agent in real time.

Session Manager

As mentioned earlier, it is desirable that a solution that enables a web server to provide messages asynchronously to a web browser enable very large distributed applications such as client/server system 100 to support large numbers of users. In general, a web server may serve many web browser clients such as web browser client 104A. For example, each agent using client/server system 100 uses a respective web browser client to access web server 188. In turn, web server 188 communicates with a business process server, such as object manager server 107, on behalf of each of these web browser clients. Each web browser client logically has its own dedicated connection from web server 188 to that business process server over which all communication for that web browser client flows. These logical connections are called sessions and are managed by a session manager.

A session manager may be comprised of a component running on each of two servers; in this example, session manager 220A runs on web server 188 and session manager 220B runs on object manager server 107. Session managers 220A and session manager 220B are referred to collectively as session manager 220. The two components of session manager 220 establish and manage a physical connection between them, such as active connection 135A, so that processes on each of the two servers 188 and 107 can communicate. Session manager 220A spawns session manager listening thread 224 to listen to active connection 135A. Session manager 220A maintains local data regarding sessions, as shown in session data 222A, and session manager 220B maintains its local session data in session data 222B.

A number of active connections can be established between the two servers. In FIG. 2, active connection 135A represents one active connection between web server 188 and object manager server 107 and additional active connections are not shown. Because each web browser client may be idle for a substantial period of time, an active connection may not be established for each web browser client to conserve networking resources and to achieve scalability. A session manager enables an active connection to be shared between web browser clients.

Whenever a component of client/server 100 needs to communicate, the component can call a corresponding session manager component on the same server computer system, which determines an active connection through which the communication will flow. For example, when web engine plug-in 185 needs to send information on behalf of a user of web browser client 104A, web engine plug-in 185 requests session manager 220A to send the information. Session manager 220A determines an active connection available to session manager 220B, such as active connection 1 35A, and sends the information to session manager 220B via that active connection. Session manager 220B provides the information to the appropriate process corresponding to web browser client 104A, user session thread 166.

A session manager such as session manager 220 may convert data to an appropriate inter-process communication protocol, used in conjunction with a transfer protocol such as TCP/IP, for communication between distributed components of client/server system 100.

Including a session manager such as session manager 220 to communicate on behalf of other components of client/server system 100 enables logic concerning connections and sessions to be removed from components performing other functionality. This simplifies the complexity of other components of client/system 100 and isolates the complexity of session and connection management as part of session manager 220.

An agent logs into client/server system 100 by accessing a web page via web server 188 and completing login information. The various connections are established in response to the login. Session manager 220 participates in establishing active connection 135A when the user logs in. Service request broker 230 and service request layers 235A and 235B participate in establishing active connection 135B when communication client service 160 requests a connection to session mode communication server 110. Java applet 116 establishes persistent HTTP connection 131 between web browser client 104A and web server 188 when the connections to session mode communication server 110 are established. In one embodiment, persistent HTTP connection 131 is a physical bidirectional socket connection from web server 188 to Java applet 116. Persistent HTTP connection 131 is dedicated to web browser client 104A and enables web server 188 to send an asynchronous message to web browser client 104A at any time. These connections enable an asynchronous message to be pushed in the embodiment presented in FIG. 4, although active connection 135B is not required for the present invention.

Active connections 135A and 135B remain active whether web browser client 104A is idle or not. These connections may be closed when the user chooses to logout (exit). These connections may also be terminated after web browser client 104A is idle for a certain length of time, such as 30 minutes. If the user has not interacted with web browser client 104 for this period of time, session manager 220 may determine that the user is no longer 1.9 available.

Prepare to Receive Asynchronous Message

FIG. 5 shows the process of preparing to receive an asynchronous message.

In action 5-1, to indicate that web browser client 104A is available to receive an asynchronous message, Java applet 116 causes web browser client 104A to send wait request 210 to web server 188. Wait request 210 may correspond to a URL as shown in FIG. 5:

http://webserver188/.../start.swe?waitrequest=1&target=160&Session_ID=104A_ID

The path element of the URL, which is the portion of the URL prior to the question mark (?), indicates a directory path name for web server 188. The search element of the URL, the portion of the URL following the question mark, provides parameters and values as name/value pairs.

In this example, the first name/value pair, waitrequest parameter 212, indicates the command to be executed by web engine plug-in 185. The target parameter 214 indicates the target process 160, which corresponds to communication client service 160, from which an asynchronous message would be received. Java applet 116 has access to the target process information because the session corresponding to web browser client 104A is already established as a result of Set Up Communication Channels step 310 of FIG. 3. The Session-ID parameter 216 indicates the Session_ID of the session. Because a session is logically “dedicated” to serving a particular web browser client 104A, the Session_ID enables web server 188 to push an asynchronous message to the corresponding web browser client. Other embodiments of the invention may provide different parameters in the URL.

Java applet 116 causes web browser client 104A to send wait request 210 in HTTP format, but the request does not “time out,” as would be the case with a standard web browser URL request. Although no immediate synchronous response is provided, web browser client 104A is not blocked while waiting for a response. Java applet 116 waits indefinitely for an asynchronous message from web server 188, and web browser client 104A is freed to perform other tasks, such as control the user interface.

In one embodiment, web server 188 recognizes the .swe extension 211 of the path element of the URL, which is the portion of the URL prior to the question mark (?). From .swe extension 211, web server 188 determines that web engine plug-in 185 will handle the request. Web server 188 provides information provided in wait request 210, such as target parameter 214 and Session_ID parameter 216, to web engine plug-in 185 in action 5-2.

In action 5-3, web engine plug-in 185 stores the information from wait request 210 in request object 510, which is stored in memory until an asynchronous message for web browser client 104A is received. Request object 510 saves the request information that will be needed to push an asynchronous message to Java applet 116, which uses the asynchronous message to control a user interface presented by web browser client 104A. For example, this information may include a user name and/or other identifying information for web browser client 104A. Optionally, web engine plug-in 185 may send a “request pending” status (not shown) back to Java applet 116. Request object 510 remains in memory and is used when session manager 220A detects that an asynchronous message has arrived via session manager listening thread 224.

Web engine plug-in 185 creates callback object 530 for the wait request 210 from request object 510, and places callback object 530 into client waiting list 550. Callback object 530 provides the context information that is used when an asynchronous message is received for web browser client 104A. Client waiting list 550 provides a list of all clients, such as web browser client 104A, that are available to receive an asynchronous message.

In action 5-4, web engine plug-in 185 calls session manager 220A, providing the wait request, a reference to a callback function to be called when an asynchronous message is received for the wait request, and a reference to the context information to be used when calling the callback function. In this example, references to callback function 540 and callback object 530 are provided. Although only a single callback function is illustrated in FIG. 4A, the scope of the invention includes multiple callback functions for different types of asynchronous messages, different types of events, or other situations in which an asynchronous message requires special handling.

Session manager 220 assigns a unique identifier for each request, Request_ID, and stores the unique identifier in session data 222A Request_ID column 222A-1, along with information that is needed when an asynchronous message is received for web browser client 104A. In the example shown in FIG. 5, the unique identifier Request_ID has a value of 104A_ID/1, indicating that this is the first request from web browser client 104A. Session manager 220A also stores a reference to the callback function in callback column 222A-2, in this case a pointer 540p. Session manager 220A also stores a reference to context information in context column 222A-3, pointer 530p, to be used when calling the callback function. In this case, the context information to be used is stored in callback object 530. In another embodiment, rather than store references to the callback function and the context information, session manager 220A may store the actual callback function and context information in session data 222A.

In action 5-5, session manager 220A sends a request including the value of Request_ID and other information, such as the value of target parameter 214 from wait request 210, to session manager 220B within object manager server 107. Session manager 220A may convert the request to an appropriate inter-process communication protocol before sending it to session manager 220B.

When session manager 220B receives the request from session manager 220B, session manager 220B determines a corresponding process to handle the request, here user session thread 166. Session manager 220B places the value of Request_ID into session data 222B Request_ID column 222B-1 and an identifier for the handler in handler column 222B-2. Session manager 220B then places the information from the request, such as the value of target 214 and the identifier for the handler, into request queue 560 in action 5-6. Request queue 560 is a common request queue for all requests received by object manager server 107 for all users and all types of services. In the example shown, request_ID column 562 includes the unique identifier Request_ID for the request, data column 564 includes the target parameter value of 160, and handler column 566 includes the identifier for user session 166. When object manager server 107 is idle, object manager server 107 retrieves a request from request queue 560 for processing, as shown by action 5-7.

When object manager server 107 retrieves the request from request queue 560, object manager server 107 obtains the identifier for the process to handle the request from handler column 566. In action 5-8, object manager server 107 provides the request to user session thread 166, and in action 5-9, user session thread 166 places information from the request into wait map 570. Wait map 570 also includes the unique identifier for the request, Request_ID, stored in Request_ID column 572, and an indicator of the process from which an asynchronous message is expected (here communication client service 160) in target column 574. Placing the Request ID into wait map 570 “registers” web browser client 104A, which is uniquely associated with the Request ID, as a client that is available to receive an asynchronous message.

Push Asynchronous Message to Web Browser

FIG. 6 illustrates the asynchronous message push to the web browser from a business process server, object manager server 107. Communication service 113, OM listening thread 234, active connection 135B-1, and service request layer 235A are included to illustrate the asynchronous push capability in the context of client/server system 100. These components are not necessary to the operation of the invention, and other embodiments of the invention may not include components that provide equivalent functionality. For example, all business logic functionality may be included in a single business process server that determines when an asynchronous message should be pushed.

In the embodiment shown, pushing the asynchronous message is triggered by the arrival of an event, such as event 610, at OM listening thread 234 via active connection 135B-1. When event 610 arrives, service request layer 235A determines the handler process to handle event 610. The process can be determined, for example, using a Session_ID provided for event 610 by Service Request Broker 230 of FIG. 4. Having determined that communication service 113 within user session thread 166 is the process to handle event 610, in action 6-1, service request layer 235A provides event 610 to communication service 113. In action 6-2, communication service 113 places event 610 into request queue 560, as indicated by the value in Request_ID column 562 of 610_ID, and identifies its counterpart, communication client service 160, as the process to handle the event in handler column 566. Data specific to event 610 is provided in data column 564.

In action 6-4, object manager server 107 retrieves event 610 from request queue 560 and provides event 610 to communication client service 160. Communication client service 160 accesses wait map 570 target column 574 to determine whether it is the target for a request in wait map 570. Finding a value of 160 in target column 574, communication client service 160 uses Request_ID column 574 to determine the unique identifier Request_ID of the request to which the event corresponds. Communication client service 160 determines an appropriate event response and generates asynchronous message 290 to include the Request_ID and an instruction to perform the event response. For example, event responses may include causing a button on toolbar 105 to blink, producing a “screen pop” of data, bringing a window for web browser client 104A to the front, and so on. Asynchronous message 290 includes an action instruction for Java applet 116 to perform the event response.

In action 6-5, communication client service 160 provides asynchronous message 290 to session manager 220B and requests session manager 220B to send asynchronous message 290.

In action 6-6, session manager 220B provides asynchronous message 290 to session manager 220A. Session manager 220A first checks client waiting list 550 to ascertain that a client is available to receive an asynchronous message. Session manager 220A matches the value of Request_ID provided in asynchronous message 290 to the value in Request_ID column 222A-1. Session manager 220A determines the callback function to call, in this case 540, and the context information to provide, callback object 530.

In action 6-7, session manager 220A provides callback object 530 to callback function 25 540. In action 6-8, callback function 540 uses request object 510 to determine the corresponding web browser client to which the asynchronous message is to be sent and pushes the asynchronous message to that web browser client.

When Java applet 116 receives an asynchronous message, persistent connection 131 is closed. To enable web browser client 104A to continue to receive asynchronous messages, Java applet 116 sends another wait request. Communication client service 160 continues to communicate with Java applet 116 to control user interface changes in a user interface presented by web browser client 104A.

When the user logs out, for example by clicking a logout button of toolbar 105, session manager 220 cleans up resources that object manager server 107 has allocated for this web browser client 104A. For example, active connection 135B-1 to Service Request Broker 230 and active connection 135B-2 to session mode communication server 110 may be closed.

The asynchronous push from web server to web browser as described herein provides many advantages, such as enabling a user having only a web browser to access a web-based application that controls a user interface providing real-time data to the user. The web browser client is not blocked, and user interface changes are made by asynchronously pushing instructions to change the user interface without the need for a request to be made by the web browser client for each user interface change.

Other Embodiments

The present invention has been described in the context of software applications running on one or more computer systems. However, those skilled in the art will appreciate that the present invention is capable of being distributed as a program product in a variety of forms, and that the present invention applies equally regardless of the particular type of signal bearing media used to actually carry out the distribution. Examples of signal bearing media include: recordable media such as floppy disks and CD-ROM and transmission media such as digital and analog communication links, as well as media storage and distribution systems developed in the future.

Additionally, the foregoing detailed description has set forth various embodiments of the present invention via the use of block diagrams, flowcharts, and examples. It will be understood by those within the art that each block diagram component, flowchart step, and operation and/or element illustrated by the use of examples can be implemented, individually and/or collectively, by a wide range of hardware, software, firmware, or any combination thereof. In one embodiment, the present invention may be implemented via Application Specific Integrated Circuits (ASICs). However, those skilled in the art will recognize that the embodiments disclosed herein, in whole or in part, can be equivalently implemented in standard integrated circuits, as a computer program running on a computer, as firmware, or as virtually any combination thereof. Designing the circuitry and/or writing the programming code for the software or firmware would be well within the skill of one of ordinary skill in the art in light of this disclosure.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are exemplary only, and are not exhaustive of the scope of the invention. Consequently, the invention is intended to be limited only by the spirit and scope of the appended claims, giving full cognizance to equivalents in all respects.

What is claimed is:

1. A method for communicating comprising:
controlling a user interface presented by a web browser comprising:
causing a web server to push an asynchronous message to the web browser;
wherein the web browser presents a user interface change in response to the asynchronous message.

2. The method of claim 1 further comprising:
generating the asynchronous message.

3. The method of claim 1 further comprising:
preparing to receive the asynchronous message.

4. The method of claim 3 wherein the preparing comprises:
causing the web browser to provide a wait request to the web server, the wait request being associated with the web browser;
identifying a source of the asynchronous message; and
associating the wait request with the source, wherein the associating identifies the web browser as a recipient of the asynchronous message.

5. The method of claim 1 further comprising:
causing the web browser to provide a wait request to the web server, the wait request being associated with the web browser;
identifying a source of the asynchronous message; and
associating the wait request with the source, wherein the associating identifies the web browser as a recipient of the asynchronous message.

6. The method of claim 1 further comprising:
causing the web browser to provide a wait request to the web server, the wait request being associated with the web browser;
generating the asynchronous message, the asynchronous message identifying the wait request, wherein the identifying identifies the web browser as a recipient of the asynchronous message; and
providing the asynchronous message to the web server.

7. The method of claim 6 wherein causing the web browser to provide the wait request comprises:
downloading requesting instructions to the web browser, wherein
the downloading causes the web browser to execute the requesting instructions.

8. The method of claim 6 further comprising:
storing a reference to a callback function with information from the wait request; and
using the reference to call the callback function when the asynchronous message is provided to the web server, wherein the callback function pushes the asynchronous message.

9. The method of claim 8 further comprising:
providing the callback function with context information, the context information identifying the web browser.

10. The method of claim 6 further comprising:
assigning the wait request to a connection between the web server and a business process server; and
listening to the connection for the asynchronous message.

11. The method of claim 6 further comprising:
assigning the wait request to a session between the web server and a business process server, the session being associated with a connection; and
listening to the connection for the asynchronous message for the session.

12. The method of claim 1 wherein causing the web server to push the asynchronous message comprises:
calling a callback function associated with the web browser when the asynchronous message is received, wherein the callback function pushes the asynchronous message.

13. The method of claim 12 further comprising:
storing a reference to the callback function; and
using the reference for calling the callback function.

14. The method of claim 13 further comprising:
storing a second reference to context information, the context information identifying the web browser; and
using the second reference for providing the context information to the callback function.

15. The method of claim 1 wherein
the user interface change comprises at least one of a group consisting of the following:
causing a first user interface object to move to visually capture a user's attention;
causing a second user interface object to issue a sound to capture the user's attention;
presenting a screen pop of data; and
bringing a web browser window to front of screen.

16. A method for communicating comprising:
causing a web server to push an asynchronous message to a web browser, wherein
the web browser performs an action in response to the asynchronous message.

17. The method of claim 16 wherein
the asynchronous message includes an action instruction to cause the web browser to perform the action.

18. The method of claim 16 wherein the performing the action comprises performing at least one of a group consisting of the following:
causing a first user interface object to move to visually capture a user's attention;
causing a second user interface object to issue a sound to capture the user's attention;
presenting a screen pop of data; and
bringing a web browser window to front of screen.

19. A method for communicating comprising:
establishing a first connection between a web browser and a web server;
establishing a second connection between the web server and a business process server;
controlling a user interface presented by the web browser comprising:
registering the web browser with the business process server;
providing the web server with an asynchronous message to push to the web browser, the providing being performed by the business process server; and
causing the web server to push the asynchronous message to the web browser;
wherein the web browser performs a user interface change in response to the asynchronous message.

20. A method for communicating comprising:
controlling a user interface presented by a web browser comprising:
registering the web browser as available to receive an asynchronous message, wherein
the web browser is not blocked waiting for the asynchronous message; and
causing a web server to push the asynchronous message to the web browser;
wherein the web browser presents a user interface change in response to the asynchronous message.

21. A method for communicating comprising:
controlling a user interface presented by a web browser comprising:
causing the web browser to provide a wait request to a web server, the wait request being associated with the web browser;
identifying a source of an asynchronous message;
associating the wait request with the source, wherein the associating identifies the web browser as a recipient of the asynchronous message; and
pushing the asynchronous message to the web browser;
wherein the browser presents a user interface change in response to the asynchronous message.

22. A method for communicating comprising:
controlling a user interface presented by a web browser comprising:
causing the web browser to provide a wait request to a web server, wherein
the wait request is associated with the web browser and a target from which an asynchronous message originates;
generating the asynchronous message, the asynchronous message identifying the web browser as a recipient of the asynchronous message, the generating being performed by the target;
providing the asynchronous message to the web server; and
causing the web server to push the asynchronous message to the web browser;
wherein the web browser presents a user interface change in response to the asynchronous message.

23. A computer program product comprising:
controlling instructions to control a user interface presented by a web browser comprising:
pushing instructions to cause a web server to push an asynchronous message to the web browser, wherein
the web browser presents a user interface change in response to the asynchronous message; and
a computer-readable medium for storing the controlling instructions and the pushing instructions.

24. The computer program product of claim 23 further comprising:
providing instructions to cause the web browser to provide a wait request to the web server, the wait request being associated with the web browser;
identifying instructions to identify a source of the asynchronous message; and
associating instructions to associate the wait request with the source, wherein the associating identifies the web browser as a recipient of the asynchronous message;
wherein the computer-readable medium further stores the providing instructions, the identifying instructions, and the associating instructions.

25. The computer program product of claim 23 further comprising:
request providing instructions to cause the web browser to provide a wait request to the web server, the wait request being associated with the web browser;
generating instructions to generate the asynchronous message, the asynchronous message identifying the wait request, wherein the identifying identifies the web browser as a recipient of the asynchronous message; and
message providing instructions to provide the asynchronous message to the web server;
wherein the computer-readable medium further stores the request providing instructions, the generating instructions, and the message providing instructions.

26. The computer program product of claim 25 further comprising:
storing instructions to store a reference to a callback function with information from the wait request; and
using instructions to use the reference to call the callback function when the asynchronous message is provided to the web server, wherein the callback function pushes the asynchronous message;
wherein the computer-readable medium further stores the storing instructions and the using instructions.

27. The computer program product of claim 26 further comprising:
context providing instructions to provide the callback function with context information, the context information identifying the web browser;
wherein the computer-readable medium further stores the context providing instructions.

28. The computer program product of claim 25 further comprising:
assigning instructions to assign the wait request to a connection between the web server and a business process server; and
listening instructions to listen to the connection for the asynchronous message;
wherein the computer-readable medium further stores the assigning instructions and the listening instructions.

29. The computer program product of claim 23 wherein
the pushing instructions comprise:
calling instructions to call a callback function associated with the web browser when the asynchronous message is received, wherein the callback function pushes the asynchronous message; and
the computer-readable medium further stores the calling instructions.

30. The computer program product of claim 29 further comprising:
reference storing instructions to store a reference to the callback function; and reference using instructions to use the reference for calling the callback function;
wherein the computer-readable medium further stores the reference storing instructions and the reference using instructions.

31. The computer program product of claim 30 further comprising:
context storing instructions to store a second reference to context information, the context information identifying the web browser; and
context using instructions to use the second reference for providing the context information to the callback function;
wherein the computer-readable medium further stores the context storing instructions and the context using instructions.

32. The computer program product of claim 23 further comprising:
user interface changing instructions configured to perform at least one of a group consisting of the following:
cause a first user interface object to move to visually capture a user's attention;
cause a second user interface object to issue a sound to capture the user's attention;
present a screen pop of data; and
bring a web browser window to front of screen;
wherein the computer-readable medium further stores the user interface changing instructions.

33. A computer program product comprising:
controlling instructions to control a user interface presented by a web browser comprising:
registering instructions to register the web browser as available to receive an asynchronous message, wherein
the web browser is not blocked waiting for the asynchronous message; and
pushing instructions to cause a web server to push the asynchronous message to the web browser, wherein the web browser presents a user interface change in response to the asynchronous message; and
a computer-readable medium for storing the controlling instructions, the registering instructions, and the pushing instructions.

34. A computer system comprising:
a processor;
a memory, the memory storing instructions for executing on the processor, the instructions comprising:
controlling instructions to control a user interface presented by a web browser comprising:
pushing instructions to cause a web server to push an asynchronous message to the web browser, wherein the web browser presents a user interface change in response to the asynchronous message.

35. The computer system of claim 34 wherein the instructions further comprise:
providing instructions to cause the web browser to provide a wait request to the web server, the wait request being associated with the web browser;
identifying instructions to identify a source of the asynchronous message; and
associating instructions to associate the wait request with the source, wherein the associating identifies the web browser as a recipient of the asynchronous message.

36. The computer system of claim 34 wherein the instructions further comprise:
request providing instructions to cause the web browser to provide a wait request to the web server, the wait request being associated with the web browser;
generating instructions to generate the asynchronous message, the asynchronous message identifying the wait request, wherein the identifying identifies the web browser as a recipient of the asynchronous message; and
message providing instructions to provide the asynchronous message to the web server.

37. The computer system of claim 36 wherein the instructions further comprise:
storing instructions to store a reference to a callback function with information from the wait request; and
using instructions to use the reference to call the callback function when the asynchronous message is provided to the web server, wherein the callback function pushes the asynchronous message.

38. The computer system of claim 37 wherein the instructions further comprise:
context providing instructions to provide the callback function with context information, the context information identifying the web browser.

39. The computer system of claim 36 wherein the instructions further comprise:
assigning instructions to assign the wait request to a connection between the web server and a business process server; and
listening instructions to listen to the connection for the asynchronous message.

40. The computer system of claim 34 wherein the pushing instructions comprise:
calling instructions to call a callback function associated with the web browser when the asynchronous message is received, wherein the callback function pushes the asynchronous message.

41. The computer system of claim 40 wherein the instructions further comprise:
reference storing instructions to store a reference to the callback function; and
reference using instructions to use the reference for calling the callback function.

42. The computer system of claim 41 wherein the instructions further comprise:
context storing instructions to store a second reference to context information, the context information identifying the web browser; and
context using instructions to use the second reference for providing the context information to the callback function.

43. The computer system of claim 34 wherein the instructions further comprise:
user interface changing instructions configured to perform at least one of a group consisting of the following:
cause a first user interface object to move to visually capture a user's attention;
cause a second user interface object to issue a sound to capture the user's attention;
present a screen pop of data; and
bring a web browser window to front of screen.

44. A computer system comprising:
a processor;
a memory, the memory storing instructions for executing on the processor, the instructions comprising:
controlling instructions to control a user interface presented by a web browser comprising:
registering instructions to register the web browser as available to receive an asynchronous message, wherein the web browser is not blocked waiting for the asynchronous message; and
pushing instructions to cause a web server to push the asynchronous message to the web browser, wherein the web browser presents a user interface change in response to the asynchronous message.

45. A system comprising:
controlling means for controlling a user interface presented by a web browser comprising:
pushing means for causing a web server to push an asynchronous message to the web browser, wherein the web browser presents a user interface change in response to the asynchronous message.

46. The system of claim 45 further comprising:
providing means for causing the web browser to provide a wait request to the web server, the wait request being associated with the web browser;
identifying means for identifying a source of the asynchronous message; and
associating means for associating the wait request with the source, wherein the associating identifies the web browser as a recipient of the asynchronous message.

47. The system of claim 45 farther comprising:
request providing means for causing the web browser to provide a wait request to the web server, the wait request being associated with the web browser;
generating means for generating the asynchronous message, the asynchronous message identifying the wait request, wherein the identifying identifies the web browser as a recipient of the asynchronous message; and
message providing means for providing the asynchronous message to the web server.

48. The system of claim 47 farther comprising:
storing means for storing a reference to a callback function with information from the wait request; and
using means for using the reference to call the callback function when the asynchronous message is provided to the web server, wherein the callback function pushes the asynchronous message.

49. The system of claim 48 farther comprising:
context providing means for providing the callback function with context information, the context information identifying the web browser.

50. The system of claim 47 further comprising:
assigning means for assigning the wait request to a connection between the web server and a business process server; and
listening means for listening to the connection for the asynchronous message.

51. The system of claim 45 wherein the pushing means comprise:
calling means for calling a callback function associated with the web browser when the asynchronous message is received, wherein the callback function pushes the asynchronous message.

52. The system of claim 51 further comprising:
reference storing means for storing a reference to the callback function; and reference using means for using the reference for calling the callback function.

53. The system of claim 52 further comprising:
context storing means for storing a second reference to context information, the context information identifying the web browser; and
context using means for using the second reference for providing the context information to the callback function.

54. The system of claim 45 further comprising:
user interface changing means configured to perform at least one of a group consisting of the following:
cause a first user interface object to move to visually capture a user's attention;
cause a second user interface object to issue a sound to capture the user's attention;
present a screen pop of data; and
bring a web browser window to front of screen.

55. A system comprising:
controlling means for controlling a user interface presented by a web browser comprising:
registering means for registering the web browser as available to receive an asynchronous message, wherein
the web browser is not blocked waiting for the asynchronous message; and
pushing means for causing a web server to push the asynchronous message to the web browser, wherein the web browser presents a user interface change in response to the asynchronous message.

56. A signal embodied in a carrier wave comprising:
controlling instructions to control a user interface presented by a web browser comprising:
pushing instructions to cause a web server to push an asynchronous message to the web browser, wherein the web browser presents
a user interface change in response to the asynchronous message.

57. A signal embodied in a carrier wave comprising:
controlling instructions to control a user interface presented by a web browser comprising:
registering instructions to register the web browser as available to receive an asynchronous message, wherein
the web browser is not blocked waiting for the asynchronous message; and
pushing instructions to cause a web server to push the asynchronous message to the web browser, wherein the web browser presents a user interface change in response to the asynchronous message.
